(19) United States
(12) Patent Application Publication
(10) Pub. No.: US 2007/0046209 A1
(43) Pub. Date: Mar. 1, 2007

(54) Plasma display panel

(76) Inventor: Jeong-Doo Yi, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 11/512,320

(22) Filed: Aug. 30, 2006

(30) Foreign Application Priority Data
Aug. 31, 2005 (KR) 10-2005-0080726

(51) Int. Cl. H01J 17/49

(52) U.S. Cl. 313/582; 313/584; 313/583

(57) ABSTRACT

A plasma display panel includes first and second substrates facing each other and having a plurality of discharge cells defined therebetween, wherein three discharge cells of a unit pixel have centers arranged in the shape of a triangle, address electrodes disposed on the first substrate and oriented along a first axis, the address electrodes corresponding to the discharge cells, and first and second electrodes disposed on the first substrate, the first and second electrodes spaced apart from the address electrodes and oriented along a second axis, the first and second electrodes corresponding to the discharge cells, wherein the second axis crosses the first axis.

### BACKGROUND OF THE INVENTION

1. Field of the Invention

The present invention relates to a plasma display panel. More particularly, the present invention relates to a plasma display panel having an arrangement of pixels and electrodes that provides a highly integrated pixel structure at an economic production cost.

2. Description of the Related Art

Generally, a plasma display panel (PDP) is a display device which displays images using colored visible light, e.g., red, green and blue (R, G and B) light, which may be generated by exciting phosphors with vacuum ultraviolet (VUV) light radiated from a gas discharge plasma. PDPs may be formed with large screen sizes while maintaining a small thickness, e.g., a large-sized screen of 60 inches or more may have a thickness on the order of 10 cm or less. The PDP is an emissive display device, which, like a cathode ray tube, does not require a separate light source and which provides good color reproduction and a wide viewing angle. In comparison with liquid crystal display devices, a PDP may be manufactured using simpler processes, more economic production costs and high productivity. Hence, the PDP has been the focus of increasing attention as a flat panel display for TV and industrial purposes.

One type of PDP is the triode surface-discharge type PDP. This PDP may include first and second substrates spaced apart and facing each other, display electrodes, e.g., sustain and scan electrodes, disposed on a same plane of the first substrate, and address electrodes disposed on the second substrate and oriented perpendicular to the sustain and the scan electrodes. A discharge gas may be injected between the first and the second substrates, which may then be sealed.

During operation of the PDP, the discharging operation for the gas discharge may employ the scan and address electrodes, which may be connected to respective signal lines and separately controlled. A sustain operation for sustaining discharge to display the desired image may employ the sustain and scan electrodes.

In such a PDP, discharge operation may consume significant amounts of power due to the scan and address electrodes being disposed on separate substrates, which may increase the discharge distance between the scan and address electrodes.

In addition, when manufacturing such a PDP, the first and second substrates should both be fired, in order to fire both the scan and the address electrodes. Accordingly, it may be necessary to employ high strength and high cost substrates for both the first and second substrates, in order to minimize substrate distortion caused by the firing process. Thus, production costs may be increased.

Moreover, increasing the resolution of the PDP typically involves reducing the spacing of adjacent discharge cells, which, in turn, reduces the distance between the corresponding address electrodes. Consequently, the capacitance C between the address electrodes increases, and, accordingly, the power consumption, which is equal to CV²f, where C is capacitance, V is voltage and f is frequency, is increased.

### SUMMARY OF THE INVENTION

The present invention is therefore directed to a plasma display panel which substantially overcomes one or more of the problems due to the limitations and disadvantages of the related art.

It is therefore a feature of an embodiment of the present invention to provide a plasma display panel having a highly integrated pixel and electrode arrangement.

It is therefore another feature of an embodiment of the present invention to provide a plasma display panel having three sets of electrodes disposed on one substrate.

At least one of the above and other features and advantages of the present invention may be realized by providing a plasma display panel including first and second substrates facing each other and having a plurality of discharge cells defined therebetween, wherein three discharge cells of a unit pixel have centers arranged in the shape of a triangle, address electrodes disposed on the first substrate and oriented along a first axis, the address electrodes corresponding to the discharge cells, and first and second electrodes disposed on the first substrate, the first and second electrodes spaced apart from the address electrodes and oriented along a second axis, the first and second electrodes corresponding to the discharge cells, wherein the second axis crosses the first axis.

Two discharge cells of the unit pixel may be adjacent to each other along the second axis and have a border therebetween, and an address electrode may be positioned at the border. The two discharge cells of the unit pixel that are adjacent along the second axis may be separated by a barrier rib, and the address electrodes may overlie the barrier rib. The address electrode may include at least one protrusion for each of the two discharge cells of the unit pixel that are adjacent along the second axis, the protrusion extending to the inside of the respective discharge cell. A same address electrode may correspond to two of the three discharge cells of the unit pixel. The two discharge cells that correspond to the same address electrode may have different colored phosphor layers.

The discharge cells may each have a substantially rectangular plan shape. The triangle may be an isosceles triangle. Two discharge cells of the unit pixel may be adjacent to each other along the first axis and have a border therebetween, and a hypothetical line extended from the border along the second axis may extend over the center of the third discharge cell of the unit pixel. Two discharge cells of the unit pixel may be adjacent to each other along the first axis, and may have centers aligned along the first axis.

Each discharge cell of the unit pixel may be operable by one of two address electrodes corresponding to the unit pixel. The first and the second electrodes may each include transparent electrodes crossing the discharge cells, and bus electrodes disposed on the transparent electrodes. The address electrodes may be covered by a first dielectric layer, the first and the second electrodes may be disposed on the first dielectric layer, and the first and the second electrodes may be covered by a second dielectric layer.

The first substrate may have a strength greater than a strength of the second substrate. The second substrate may define a side wall of the discharge cells and may be formed of soda lime glass.

At least one of the above and other features and advantages of the present invention may also be realized by providing a plasma display panel including first and second substrates defining a discharge region therebetween, the discharge region having a plurality of subpixels, a plurality of address electrodes disposed on the first substrate and oriented along a first axis, and a plurality of display electrodes disposed on the first substrate and oriented along a second axis, the second axis crossing the first axis, wherein a unit pixel is defined by three adjacent subpixels, first and second ones of the three subpixels adjoining each other along the first axis and a third one of the three subpixels adjoining each of the first and second subpixels along the second axis, and the plasma display panel is configured to drive each unit pixel using first and second address electrodes, the first address electrode driving the first and second subpixels and the second address electrode driving the third subpixel.

The first address electrode may be disposed along a first edge of the third subpixel and the second address electrode may be disposed along a second edge of the third subpixel, the second edge being opposite the first edge. The first address electrode may include a protrusion extending partially across the first subpixel, the first address electrode may include another protrusion extending partially across the second subpixel, and the second address electrode may include a protrusion extending partially across the third subpixel. The address electrodes may be arranged at border regions defined by adjoining subpixels, and the display electrodes may be arranged across interior regions of the subpixels.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a partial exploded perspective view of a PDP according to an embodiment of the present invention;

FIG. 2 illustrates a plan view of an arrangement of discharge cells and electrodes in the PDP of FIG. 1; and

FIG. 3 illustrates a cross sectional view of the PDP of FIG. 1, taken along the line III-III.

### DETAILED DESCRIPTION OF THE INVENTION

Korean Patent Application No.10-2005-0080726, filed on Aug. 31, 2005, in the Korean Intellectual Property Office, and entitled: “Plasma Display Panel” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Moreover, it will be understood that spatially relative terms such as “front” and “rear” may be interchanged, and that reference to an axis of orientation includes translations of the axis. It will also be understood that the term “phosphor” is intended to generally refer to a material that can generate visible light upon excitation by electrons that impinge thereon, and is not intended be limited to materials the undergo light emission through any particular mechanism or over any particular time frame. Like reference numerals refer to like elements throughout.

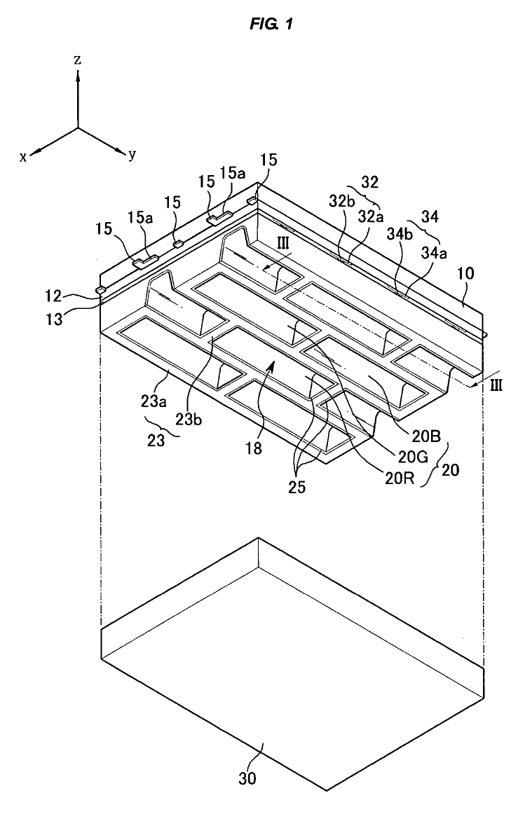

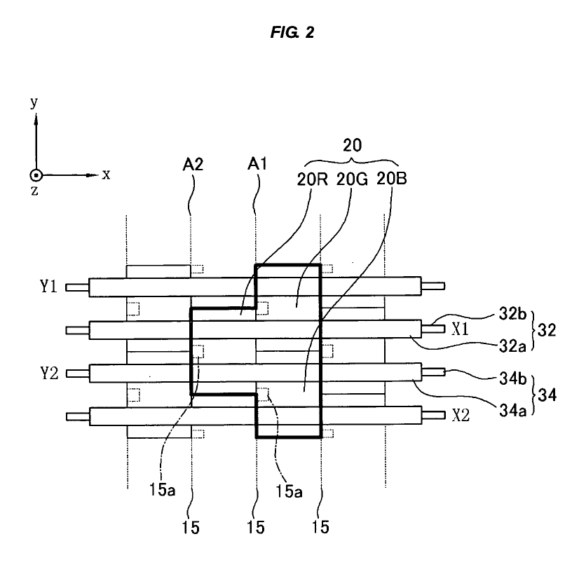

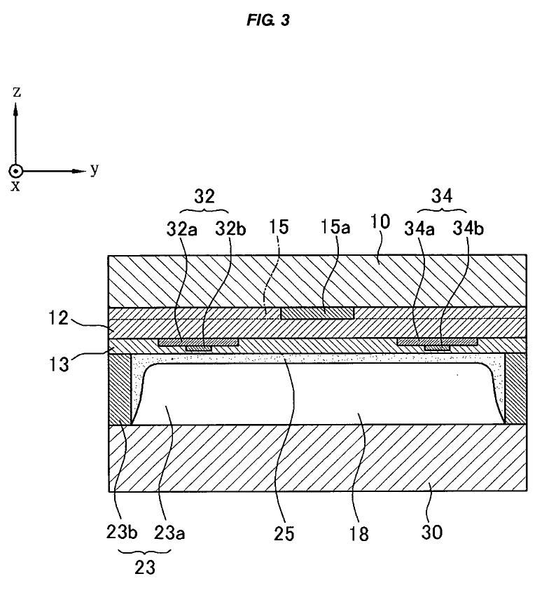

FIG. 1 illustrates a partial exploded perspective view of a PDP according to an embodiment of the present invention, FIG. 2 illustrates a plan view of an arrangement of discharge cells and electrodes in the PDP of FIG. 1, and FIG. 3 illustrates a cross sectional view of the PDP of FIG. 1, taken along the line III-III. Referring to FIGS. 1-3, a PDP according to an embodiment of the present invention may include a pixel arrangement wherein the centers of three subpixels, e.g., subpixels for generating red, green and blue visible light, are arranged in the shape of a triangle to form a unit pixel. Such an arrangement may be referred to as a delta arrangement. The triangle may be an isosceles triangle.

The PDP may include a first substrate 10, which may be a front substrate, and a second substrate 30, which may be a rear substrate. The front and rear substrates 10 and 30 may be arranged facing each other in parallel, separated by a predetermined distance and sealed to each other.

Barrier ribs 23 may be disposed between the front and the rear substrates 10 and 30, the barrier ribs 23 having a predetermined height. The barrier ribs 23 may be arranged to define pixels 20, e.g., having a pattern in which a unit pixel 20 includes three subpixels 20R, 20G and 20B arranged in the shape of a triangle. The subpixels 20R, 20G and 20B may each include a discharge cell 18, which may be defined by the barrier ribs 23.

The barrier ribs 23 may include a first barrier rib member 23a oriented along a first axis, e.g., along the y-axis in the drawings, and a second barrier rib member 23b oriented along a second axis, e.g., along the x-axis in the drawings. The first axis crosses the second axis and may be perpendicular thereto. The second barrier rib member 23b may be disposed between adjacent first barrier rib members 23a.

Referring to FIG. 2, in plan view the respective subpixels 20R, 20G and 20B may be generally rectangular, and the barrier ribs 23 defining the subpixels 20R, 20G and 20B may similarly define openings that are generally rectangular. Each discharge cell 18 of the respective subpixels 20R, 20G and 20B may have a hexahedral box shape, except for an open side. The open side may be the bottom side facing the rear substrate 30.

The discharge cells 18 may be filled with a discharge gas containing, e.g., xenon (Xe) and neon (Ne), which supports the plasma discharge. Red, green and blue phosphor layers 25 may be respectively disposed in the discharge cells 18 corresponding to the subpixels 20R, 20G and 20B, the phosphor layers 25 generating red, green and blue visible light, R, G and B, respectively. As shown in FIG. 3, each phosphor layer 25 may be formed on the bottom surface of the respective discharge cell 18, i.e., the surface opposite the open side of the discharge cell, and on the lateral surfaces of the corresponding barrier ribs 23.

The address electrodes 15 may be arranged on the front substrate 10 so as to be oriented along the first axis, e.g., along to the y-axis. Adjacent address electrodes 15 may be parallel to each other and spaced apart along the second axis by a predetermined distance. The address electrodes 15 may be arranged corresponding to the respective discharge cells 18. In particular, the address electrodes 15 may be aligned with the first barrier rib members 23a. Thus, the address electrodes 15 may be arranged on top of the barrier ribs 23.

Referring to FIGS. 1 and 2, the address electrodes 15 may include protrusions 15a that project partially across the discharge cells 18. Such a structure may enable the address electrodes 15 to select only the discharge cell 18 over which the protrusion 15a projects.

The address electrodes 15 may be disposed on the front substrate 10, and may be covered by a first dielectric layer 12 disposed on the entire surface of the front substrate 10.

First electrodes 32, which may be sustain electrodes X, and second electrodes 34, which may be scan electrodes Y, may be disposed on the first dielectric layer 12 of the front substrate 10 and oriented along the second axis. The sustain and the scan electrodes 32 and 34 may correspond to each other at the respective discharge cells 18 and may be spaced apart to have a discharge gap therebetween. The sustain and the scan electrodes 32 and 34 may alternate along the first axis.

The sustain and scan electrodes 32 and 34 may include transparent electrodes 32a and 34a, and bus electrodes 32b and 34b, respectively. The transparent electrodes 32a and 34a may be disposed on the first dielectric layer 12 on the front substrate 10, may be oriented along the second axis, and may have a predetermined line width. A pair of the transparent electrodes 32a and 34a may be separated from each other by a predetermined distance and may face each other within a discharge cell 18. The transparent electrodes 32a and 34a may be formed of a transparent material, e.g., indium tin oxide (ITO).

The bus electrodes 32b and 34b may be disposed on the transparent electrodes 32a and 34a, and may be oriented along the transparent electrodes 32a and 34a. The bus electrodes 32b and 34b may be formed of a metal or other material having excellent electrical conductivity.

The size and spacing of the transparent electrodes 32a and 34a may define the discharge gap therebetween, and the bus electrodes 32b and 34b may have a line width narrower than that of the transparent electrodes 32a and 34a. The bus electrodes 32b and 34b may have a line width that is reduced as much as possible while maintaining reasonable electrical conductivity. By configuring the bus electrodes 32b and 34b to have a narrow line width, the visible light generated in the discharge cell 18 may be minimally intercepted, even where the bus electrodes 32b and 34b are formed with an opaque material such as a metal.

A second dielectric layer 13 may be disposed on the entire surface of the first dielectric layer 12 such that it covers the sustain and the scan electrodes 32 and 34. A protective film (not shown), e.g., an MgO film, may be disposed on the second dielectric layer 13.

The address electrodes 15, the sustain electrodes 32, the scan electrodes 34 and the barrier ribs 23 may all be formed on the front substrate 10. Accordingly, it may be desirable to form the front substrate 10 from a high strength material. In particular, where the respective structural components provided on the front substrate 10 differ in firing temperature from each other, the front substrate 10 may have a high enough strength to withstand the highest firing temperature, so as to reduce or eliminate distortion of the front substrate 10. The front substrate 10 may be formed of, e.g., reinforced glass.

Correspondingly, as the electrodes and barrier ribs may all be formed on the front substrate 10 and not on the rear substrate 30, it may not be necessary to heat the rear substrate 30 to fire electrodes or barrier ribs. Therefore, the rear substrate 30 may be subjected to lower temperatures during manufacturing and, accordingly, may be formed of a material such as a low cost soda lime glass, i.e., a lower strength material. Accordingly, in a PDP according to an embodiment of the present invention, the rear substrate 30 may be formed with a low cost material to reduce production costs.

Referring again to FIG. 2, among the three discharge cells 18 making up the three subpixels 20R, 20G and 20B of the pixel 20, two discharge cells 18 may be arranged in parallel and adjacent to each other along the first axis, e.g., arranged along a same line along the y-axis in FIG. 2. Additionally, two address electrodes 15 may be arranged at each pixel 20.

At least two of the subpixels 20R, 20G and 20B forming one pixel 20 may correspond to a same address electrode 15 of the two address electrodes 15 provided for the pixel 20. Additionally, two of the scan electrodes 34 may be arranged at the pixel 20. Thus, the address discharge at the three subpixels 20R, 20G and 20B of the pixel 20 may be controlled by the two address electrodes 15 and the two scan electrodes 34 corresponding to the individual pixel 20.

The interrelation of the respective structural components of the PDP will be now explained in greater detail with reference to FIG. 2. Among the three subpixels 20R, 20G and 20B forming one pixel 20, the two adjacent subpixels, e.g., green and blue subpixels 20G and 20B, neighboring each other along the first axis may correspond to a first address electrode 15 A1. The two subpixels 20G and 20B corresponding to the first address electrode 15 A1 may have phosphor layers 25 generating different colored visible light. The remaining one subpixel of the pixel 20, e.g., red subpixel 20R, may correspond to a second address electrode 15 A2.

Furthermore, among the three subpixels 20R, 20G and 20B forming the pixel 20, the first scan electrode 34 Y1 may be disposed over one subpixel of the three subpixels, e.g., the green subpixel 20G. A second scan electrode 34 Y2 may be disposed over the remaining two subpixels, e.g., subpixels 20R and 20B, which may be adjacent to each other along the second axis. The two subpixels corresponding to the same scan electrode 34 Y2 may have phosphor layers 25 generating different colored light, e.g., red and blue light.

The scan and the sustain electrodes 34 and 32 may be arranged together at the respective discharge cells 18 so that the first and the second sustain electrodes 32 X1 and X2 corresponding to the first and the second scan electrodes 34 Y1 and Y2 may also be arranged at the same pixel 20. The two sustain electrodes 32 X1 and X2 and the two scan electrodes 34 Y1 and Y2 may respectively face each other at the one pixel 20.

The arrangement of the sustain and the scan electrodes 32 and 34 at each pixel 20 may be as described above or may be different, depending upon the arrangement of the pixels 20.

According to this embodiment of the present invention, the respective discharge cells 18 forming the respective subpixels 20R, 20G and 20B may have a generally rectangular shape in plan view. Accordingly, the discharge cells 18 may have four sides. A hypothetical line extended from a border between a pair of the discharge cells 18 that are adjacent to each other along the first axis, i.e., a hypothetical line oriented along the second axis, may extend over the centers of discharge cells 18 that are adjacent along the second axis on either side of the pair of discharge cells.

According to this embodiment of the present invention, the centers of the three subpixels 20R, 20G and 20B forming one pixel 20 may be arranged in the shape of a triangle, while the sustain and the scan electrodes 32 and 34 may be arranged rectilinearly, such that they may be disposed over two of the three subpixels 20R, 20G and 20B. That is, the second scan electrode 34 Y2 may be disposed over the two neighboring subpixels 20R and 20B to apply a common voltage thereto, and the first scan electrode 34 Y1 may be disposed over the remaining one subpixel 20G of the pixel 20 to apply a voltage thereto.

The sustain electrodes 32 may face respective scan electrodes 34. In particular, the first sustain electrode 32 X1 may face the first scan electrode 34 Y1 and may be disposed over the remaining two subpixels of the pixel 20, e.g., subpixels 20R and 20G, to apply a voltage thereto. The second sustain electrode 32 X2 may face the second scan electrode 34 Y2 and may be disposed over one of the subpixels of the pixel 20, e.g., subpixel 20B, to apply a voltage thereto. Furthermore, the first sustain electrode 32 X1 may be disposed between the first and the second scan electrodes Y1 and Y2 along the first axis.

Accordingly, the scan and the sustain electrodes 34 and 32 may be alternately arranged in the direction parallel to the address electrode 15, e.g., they may alternate along the y-axis, to control the driving of the respective discharge cells 18.

For a given individual unit pixel 20, the address electrodes 15 may be arranged in pairs and the scan electrodes 34 may also arranged in pairs. Conventionally, a pixel is allocated three address electrodes. However, in a PDP according to an embodiment of the present invention, each pixel 20 may be provided with only two address electrodes. Consequently, for a PDP having a given number of overall pixels 20, the number of address electrodes 15 may be reduced by one-third in a PDP according to an embodiment of the present invention. Additionally, this may allow for a corresponding reduction in the number of address electrode terminals (not shown). Therefore, the terminal structure for the address electrodes 15 of the PDP may have a simplified design.

For example, increasing the resolution of a conventional PDP to 1920×1080 (FHD, full high definition) would significantly increase the number of terminals required for address electrodes, and the power consumption would significantly increase due to increased crosstalk and capacitance. By comparison, in a PDP according to an embodiment of the present invention, the number of address electrodes 15 may be reduced by one-third, which may result in power consumption by the address electrodes 15 being reduced by one-third as compared to a conventional PDP. Furthermore, the peak power for corresponding active address components, e.g., a tape carrier package TCP, may also be reduced by one-third as compared to a conventional PDP.

As described above, in a PDP according to an embodiment of the present invention, one address electrode may correspond to two of the three subpixels forming each unit pixel. Consequently, the number of address electrodes per unit pixel may be reduced, and addressing power consumption may be reduced while increasing the resolution of the PDP.

Furthermore, in a PDP according to an embodiment of the present invention, address and scan electrodes may be formed together on the front substrate so that the distance between the address and the scan electrodes is reduced, which may help reduce addressing power consumption.

In addition, in a PDP according to an embodiment of the present invention, electrodes and barrier ribs may all be provided on one substrate, and hence, it may be possible to use a soda lime glass-based material for the opposite substrate, thereby reducing production costs.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel, comprising:
first and second substrates facing each other and having a plurality of discharge cells defined therebetween, wherein three discharge cells of a unit pixel have centers arranged in the shape of a triangle;
address electrodes disposed on the first substrate and oriented along a first axis, the address electrodes corresponding to the discharge cells; and
first and second electrodes disposed on the first substrate, the first and second electrodes spaced apart from the address electrodes and oriented along a second axis, the first and second electrodes corresponding to the discharge cells, wherein the second axis crosses the first axis.

2. The plasma display panel as claimed in claim 1, wherein two discharge cells of the unit pixel are adjacent to each other along the second axis and have a border therebetween, and an address electrode is positioned at the border.

3. The plasma display panel as claimed in claim 2, wherein the two discharge cells of the unit pixel that are adjacent along the second axis are separated by a barrier rib, and the address electrodes overlies the barrier rib.

4. The plasma display panel as claimed in claim 2, wherein the address electrode includes at least one protrusion for each of the two discharge cells of the unit pixel that are adjacent along the second axis, the protrusion extending to the inside of the respective discharge cell.

5. The plasma display panel as claimed in claim 1, wherein a same address electrode corresponds to two of the three discharge cells of the unit pixel.

6. The plasma display panel as claimed in claim 5, wherein the two discharge cells that correspond to the same address electrode have different colored phosphor layers.

7. The plasma display panel as claimed in claim 1, wherein the discharge cells each have a substantially rectangular plan shape.

8. The plasma display panel as claimed in claim 1, wherein the triangle is an isosceles triangle.

9. The plasma display panel as claimed in claim 1, wherein two discharge cells of the unit pixel are adjacent to each other along the first axis and have a border therebetween, and a hypothetical line extended from the border along the second axis extends over the center of the third discharge cell of the unit pixel.

10. The plasma display panel as claimed in claim 1, wherein two discharge cells of the unit pixel are adjacent to each other along the first axis, and have centers aligned along the first axis.

11. The plasma display panel as claimed in claim 1, wherein each discharge cell of the unit pixel is operable by one of two address electrodes corresponding to the unit pixel.

12. The plasma display panel as claimed in claim 1, wherein the first and the second electrodes each include:
transparent electrodes crossing the discharge cells, and bus electrodes disposed on the transparent electrodes.

13. The plasma display panel as claimed in claim 1, wherein the address electrodes are covered by a first dielectric layer, the first and the second electrodes are disposed on the first dielectric layer, and the first and the second electrodes are covered by a second dielectric layer.

14. The plasma display panel as claimed in claim 1, wherein the first substrate has a strength greater than a strength of the second substrate.

15. The plasma display panel as claimed in claim 1, wherein the second substrate defines a side wall of the discharge cells and is formed of soda lime glass.

16. A plasma display panel, comprising:
first and second substrates defining a discharge region therebetween, the discharge region having a plurality of subpixels;
a plurality of address electrodes disposed on the first substrate and oriented along a first axis; and
a plurality of display electrodes disposed on the first substrate and oriented along a second axis, the second axis crossing the first axis, wherein:
a unit pixel is defined by three adjacent subpixels, first and second ones of the three subpixels adjoining each other along the first axis and a third one of the three subpixels adjoining each of the first and second subpixels along the second axis, and
the plasma display panel is configured to drive each unit pixel using first and second address electrodes, the first address electrode driving the first and second subpixels and the second address electrode driving the third subpixel.

17. The plasma display panel as claimed in claim 16, wherein the first address electrode is disposed along a first edge of the third subpixel and the second address electrode is disposed along a second edge of the third subpixel, the second edge being opposite the first edge.

18. The plasma display panel as claimed in claim 17, wherein the first address electrode includes a protrusion extending partially across the first subpixel,
the first address electrode includes another protrusion extending partially across the second subpixel, and
the second address electrode includes a protrusion extending partially across the third subpixel.

19. The plasma display panel as claimed in claim 16, wherein the address electrodes are arranged at border regions defined by adjoining subpixels, and
the display electrodes are arranged across interior regions of the subpixels.
